(19) United States
(12) Patent Application Publication
(10) Pub. No.: US 2015/0276609 A1
(43) Pub. Date: Oct. 1, 2015

(54) LIGHT SOURCE APPARATUS AND INFORMATION-OBTAINING APPARATUS USING THE SAME

(71) Applicant: CANON KABUSHIKI KAISHA, Tokyo (JP)

(72) Inventors: Yukihiro Inoue, Tucson, AZ (US); Yuki Yonetani, Utsunomiya-shi (JP)

(21) Appl. No.: 14/671,981

(22) Filed: Mar. 27, 2015

(30) Foreign Application Priority Data
Mar. 31, 2014 (JP) 2014-074581

(51) Int. Cl. G01N 21/65

(52) U.S. Cl. CPC G01N 21/65; G01N 2021/655; G01N 2201/06113

(57) ABSTRACT

A light source apparatus emitting two pulse lights of which center wavelengths are different from each other, and an information-obtaining apparatus for use with a light source apparatus, are provided. In at least one embodiment, the light source apparatus may include a light source configured to emit a first pulse light of which a center wavelength is variable, a nonlinear optical medium configured to generate a second pulse light having a center wavelength different from the first pulse light in response to incidence of the first pulse light, and a wavelength dispersion adjustment device configured to give a wavelength dispersion to the second pulse light, wherein a wavelength dispersion amount given by the wavelength dispersion adjustment device to the second pulse light is variable. In one or more embodiments, a light source apparatus may include an adjustment unit to adjust a chirp rate of the second pulse light.

### BACKGROUND OF THE INVENTION

1. Field of the Invention

The present inventions relate to light source apparatuses, such as, but not limited to, a light source apparatus emitting two pulse lights of which a center wavelength difference is variable, and to an information-obtaining apparatus using the same.

2. Description of the Related Art

Various kinds of information about constituent materials of a subject can be obtained by emitting a pulse light to the subject and detecting light reflected or scattered by the subject, detecting light passing through the subject, or detecting fluorescence emitted from the subject.

In recent years, researches have been actively conducted, in which two pulse lights having a frequency difference corresponding to a molecular vibration number are emitted onto a subject, and light based on Stimulated Raman Scattering (SRS) and coherent anti-Stokes Raman scattering (CARS) that occurs with the subject, so that the material of the subject is identified.

A optical parametric amplifier using four-wave mixing (a type of optical parametric effect) generated by optical fiber (hereinafter abbreviated as FOPA) is known as a laser light source that generates two pulse lights of which center wavelengths are different from each other. The FOPA receives energy of excitation pulse light incident upon the optical fiber and generates a signal pulse of which wavelength is different from the excitation pulse light.

Optics Express Vol. 20, No. 19, pp. 21010-21018, 10 Sep. 2012 discloses a method of imaging by detecting light based on CARS upon emitting an excitation pulse light incident on the FOPA and a generated pulse light generated by the FOPA onto a subject.

Although the excitation pulse light and the generated pulse light used in Optics Express Vol. 20, No. 19, pp. 21010-21018, 10 Sep. 2012 have wavelengths different from each other, the wavelengths thereof are fixed, and therefore, the difference of the wavelengths of these pulse lights are also fixed. In order to identify many types of materials using an information-obtaining apparatus using SRS and CARS, it is necessary to obtain Raman spectrums corresponding to various molecular vibration numbers. Therefore, it is required to perform scanning so that the center wavelength difference (frequency difference) between the excitation pulse light and the generated pulse light can cope with the molecular vibration numbers of various materials.

Therefore, there may be a method of scanning the frequency difference of the excitation pulse light and the generated pulse light by using characteristics of four-wave mixing of FOPA in which the center wavelength of the generated pulse light greatly changes in response to a slight change in the center wavelength of the excitation pulse light.

When the center wavelength of the excitation pulse light is changed, this causes a change in the spectrum width of the generated pulse light generated by four-wave mixing, but the pulse width of the generated pulse light stays the same regardless of the center wavelength of the excitation pulse light. More specifically, the chirp rate of the generated pulse light (the rate of the spectrum width and the pulse width) changes in accordance with the center wavelength of the excitation pulse light. The excitation pulse light has substantially the constant spectrum width and the constant pulse width regardless of the wavelength, and the chirp rate is also constant, and therefore, when the center wavelength of the excitation pulse light changes, the chirp rates of the excitation pulse light and the generated pulse light do not match each other.

When the chirp rates of the two pulse lights emitted on the subject are different from each other, there occurs a frequency difference component that does not match a molecular vibration number in a frequency difference of two pulse lights in a pulse width during measurement of a molecule having a certain molecular vibration number. For this reason, a Raman spectrum obtained from a subject includes a noise due to the frequency difference component that does not match the molecular vibration number, and there is a problem in that the spectral resolution deteriorates.

### SUMMARY OF THE INVENTION

A light source apparatus according to one or more of the present inventions is a light source apparatus emitting two pulse lights of which a center wavelength difference is variable, and the light source apparatus includes a light source configured to emit a first pulse light of which a center wavelength is variable, a nonlinear optical medium configured to generate a second pulse light having a center wavelength different from the first pulse light in response to incidence of the first pulse light, and a wavelength dispersion adjustment device configured to give a wavelength dispersion to the second pulse light, wherein a wavelength dispersion amount given by the wavelength dispersion adjustment device is variable. In one or more other embodiments, a light source apparatus may include: a light source configured to emit a first pulse light of which a center wavelength is variable; a nonlinear optical medium configured to generate a second pulse light having a center wavelength different from the first pulse light in response to incidence of at least a portion of the first pulse light and having a wavelength dispersion; and a first adjustment unit configured to adjust a chirp rate of the second pulse light corresponding to a changing center wavelength of the first pulse light.

An information-obtaining apparatus according to one or more of the present inventions is an information-obtaining apparatus configured to emit two pulse lights of which a center wavelength difference is variable to a subject, and obtain information about the subject by detecting at least one of a light reflected by the subject, a light passing through the subject, and a light emitted in the subject. The information-obtaining apparatus includes a light source apparatus configured to emit two pulse lights of which a center wavelength difference is variable, and a light reception device configured to receive at least one of a light reflected by the subject, a light passing through the subject, and a light emitted in the subject. In one or more embodiments, the light source apparatus included in the information-obtaining apparatus may be the aforementioned light source apparatus including a light source, a nonlinear optical medium and a wavelength dispersion adjustment device, wherein a wavelength dispersion amount given by the wavelength dispersion adjustment device is variable.

According to other aspects of the present inventions, one or more other light source apparatuses, one or more other information-obtaining apparatuses, and method(s) of using same, are discussed herein. Further features of the present inventions will become apparent from the following description of exemplary embodiments (with reference to the attached drawings).

### BRIEF DESCRIPTION OF THE DRAWINGS

FIG. 1 is a schematic view for explaining a light source apparatus according to a first embodiment.

FIG. 2 is a schematic view for explaining a light source apparatus according to a second embodiment.

FIG. 3 is a schematic view for explaining a light source apparatus according to a third embodiment.

FIG. 4 is a schematic view for explaining an information-obtaining apparatus according to the first embodiment.

FIGS. 5A and 5B are spectrograms illustrating distributions of a time component and a frequency component included in excitation pulse light and generated pulse light in the light source apparatus according to the first embodiment.

FIGS. 6A and 6B are spectrograms illustrating distributions of a time component and a frequency component included in excitation pulse light and generated pulse light in the light source apparatus according to the third embodiment.

FIGS. 7A and 7B are graphs illustrating a parametric gain G and a phase mismatching Δβ of a propagation constant of light in a nonlinear optical medium where β₂>0 and β₄>0 hold.

FIGS. 8A and 8B are graphs illustrating a parametric gain G and a phase mismatching Δβ of a propagation constant of light in a nonlinear optical medium where β₂>0 and β₄<0 hold.

FIGS. 9A and 9B are graphs illustrating a parametric gain G and a phase mismatching Δβ of a propagation constant of light in a nonlinear optical medium where β₂<0 and β₄>0 hold.

FIGS. 10A and 10B are graphs illustrating a parametric gain G and a phase mismatching Δβ of a propagation constant of light in a nonlinear optical medium where β₂<0 and β₄<0 hold.

### DESCRIPTION OF THE EMBODIMENTS

A light source apparatus includes a light source configured to emit an excitation pulse light of which a center wavelength is variable, a dividing device configured to divide the light into an excitation pulse light and a generated pulse light, and a nonlinear optical medium configured to generate a generated pulse light. Further, a wavelength dispersion adjustment device configured to adjust at least a wavelength dispersion of the generated pulse light is provided. The nonlinear optical medium is preferably a light fiber, and more particularly, a photonic crystal fiber and a taper fiber.

When the excitation pulse light emitted by the light source is incident upon the nonlinear optical medium, the generated pulse light having a wavelength different from the excitation pulse light is generated according to an optical parametric gain of the nonlinear optical medium. At this occasion, when the center wavelength of the excitation pulse light is slightly changed, the center wavelength of the generated pulse light generated according to the optical parametric gain greatly changes. Therefore, the light source apparatus can change the center wavelength difference of two emitted pulse lights over a wide range. More specifically, the light source apparatus can change the frequency difference over a wide range.

When the center wavelength of the excitation pulse light incident upon the nonlinear optical medium is changed, the spectrum width of the optical parametric gain changes, and the spectrum width of the generated pulse light generated also changes, but the pulse duration thereof does not change. More specifically, the chirp rate of the generated pulse light (the ratio between the spectrum width and the pulse duration) changes according to the center wavelength of the excitation pulse light. However, the excitation pulse light has substantially the constant spectrum width and the constant pulse duration regardless of the wavelength, and the chirp rate thereof is also constant. Therefore, because of the change in the center wavelength of the excitation pulse light, the chirp rate of the generated pulse light and the chirp rate of the excitation pulse light do not match each other, and the spectral resolution of the Raman spectrum obtained from the subject deteriorates.

Therefore, in accordance with the change in the center wavelength of the excitation pulse light, at least the chirp rate of the generated pulse light is adjusted by the wavelength dispersion adjustment device. More specifically, the wavelength dispersion adjustment device gives a wavelength dispersion to the generated pulse light in accordance with the change in the center wavelength of the excitation pulse light, thus changing the pulse duration of the generated pulse light, and successively adjusting the chirp rate of the generated pulse light.

The principle of generation of four-wave mixing, which is the source of the optical parametric gain generating the generated pulse light from the excitation pulse light, will be explained prior to explaining embodiments of the apparatus(es) discussed herein in greater detail.

The four-wave mixing means a phenomenon in which, when two lights (excitation lights) of which frequencies (wavelengths) are different from each other are incident upon an optical fiber which is a nonlinear optical medium, a new light is generated at a wavelength that does not match any of the wavelengths of the excitation light. At this occasion, a part of energy of the light incident upon the fiber is converted into energy of light that is newly generated by the four-wave mixing. For example, when two lights of which frequencies are ω₁ and ω₂, respectively, are incident upon an nonlinear optical medium 103, and two lights of which frequencies are ω₃ and ω₄, respectively, are newly generated, the frequencies thereof satisfy the relationship of ω₁+ω₂=ω₃+ω₄.

When the incident light (excitation light) has a single frequency, and more specifically, when ω₁=ω₂=ω_{C} holds, this is referred to as degenerate four-wave mixing, and two lights of which frequencies are ω_{C}+Δω and ω_{C}−Δω, respectively, are generated in a symmetric manner with respect to the frequency ω_{C}. In general, a high frequency side is referred to as a signal light, and a low frequency side is referred to as an idler light. In this specification, both are collectively referred to as, or any one of them is referred to as a generated pulse light. Hereinafter, the frequency of the signal light will be denoted as ω_{S1} (=ω_{C}+Δω), and the frequency of the idler light will be denoted as ω_{S2} (=ω_{C}−Δω).

The degenerate four-wave mixing is simpler in terms of the control of wavelength and the structure than the case where two lights of which frequencies are different from each other are incident, and therefore, the degenerate four-wave mixing is widely used for the light source of the information-obtaining apparatus using SRS and CARS. Hereinafter, the degenerate four-wave mixing will be explained.

In order to efficiently generate the degenerate four-wave mixing, it is necessary to satisfy the phase matching condition represented by the following expression where the propagation constant of the excitation light incident upon the nonlinear optical medium is denoted as β_{C}, the propagation constant of the signal light is denoted as β_{S1}, and the propagation constant of the idler light is denoted as β_{S2}.

$$- 4 {γP}_{c} < Δ β = {β}_{s 1} + {β}_{s 2} - 2 {β}_{c} < 0 γ = \frac{{ω}_{c}}{c} \frac{{n}_{2}}{{A}_{eff}} \qquad Expression 1$$

Δβ denotes phase mismatching of a propagation constant of each light in a nonlinear optical medium. γ denotes a nonlinear coefficient of the nonlinear optical medium. P_{C} denotes a peak strength of the excitation light. n₂ denotes a nonlinear refraction index of the nonlinear optical medium. A_{eff} denotes an effective cross-sectional area of a core of an optical fiber which is the nonlinear optical medium. c denotes the speed of light in vacuum.

The phase mismatching Δβ of the propagation constant of each light in the nonlinear optical medium can be represented by the following expression using the frequency difference Δω.

Δβ=β₂(Δω)²+β₄(Δω)⁴/12 Expression 2

However, β₂ denotes a group velocity dispersion at a frequency of the excitation light in the nonlinear optical medium. β₄ denotes a secondary derived function of the group velocity dispersion β₂. It should be noted that the group velocity dispersion β₂ is a secondary derived function of the propagation constant β_{C} of the excitation light.

The optical parametric gain G at this occasion is represented by the following expression.

$$G = {\vert \frac{sin h \sqrt{1 - {( 1 + Δ β / 2 γ {P}_{c} )}^{2} γ {P}_{c} L )}}{\sqrt{1 - {( 1 + Δ β / 2 γ {P}_{c} )}^{2}}} \vert}^{2} \qquad Expression 3$$

L denotes a length of the nonlinear optical medium.

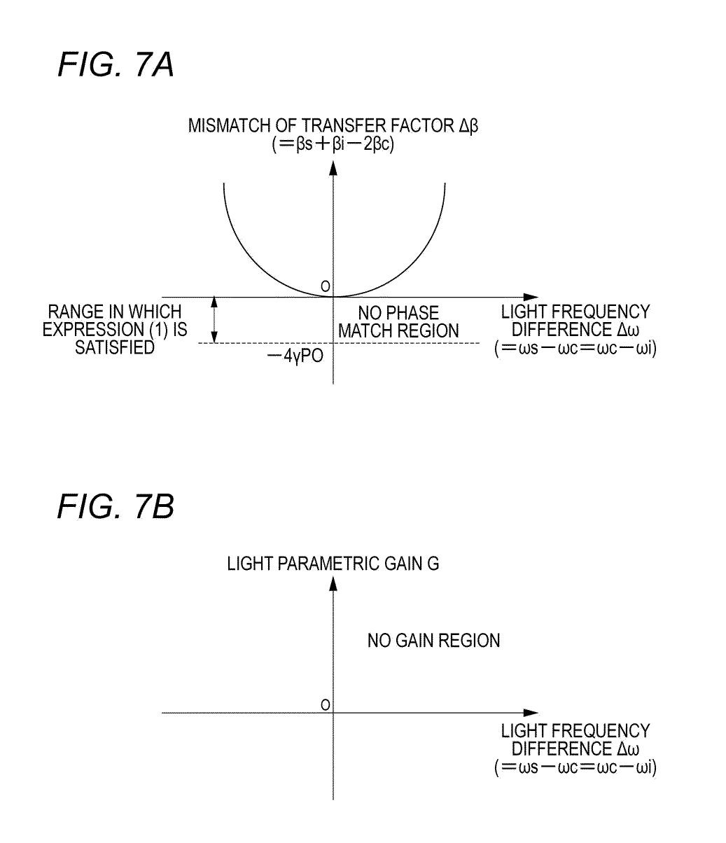

FIGS. 7A to 10B show graphs derived from Expression (2), Expression (3) with regard to four cases where β₂ and β₄ are positive or negative.

FIGS. 7A and 7B illustrate a case where β₂>0 and β₄>0 hold. FIG. 7A is a graph derived from Expression (2), and the vertical axis is Δβ, and the horizontal axis is Δω. FIG. 7 (b) is a graph derived from Expression (3), and the vertical axis is G, and the horizontal axis is Δω. This is also applicable to the graphs in FIGS. 7A to 10B.

In the phase matching condition of Δβ represented by Expression (1), both of the nonlinear coefficient γ of the nonlinear optical medium and the peak strength P_{C} of the excitation light are positive values, and Δβ is a negative value. However, as can be understood from FIG. 7A, in a case where β₂>0 and β₄>0 hold, there is no area satisfying Expression (1). More specifically, the optical parametric gain G represented by Expression (3) cannot be obtained, in such nonlinear optical medium, neither signal light nor idler light is generated even if the excitation light is incident thereupon.

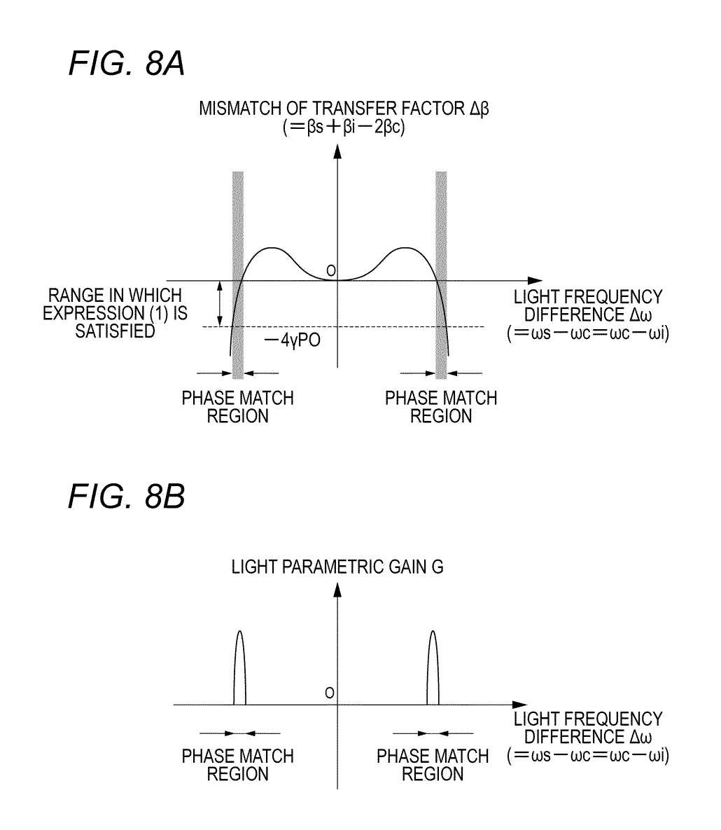

FIGS. 8A and 8B illustrate a case where β₂>0 and β₄<0 hold. In the graph of FIG. 8A, the range where the phase matching condition of Δβ represented by Expression (1) is indicated by hatching. It is understood from the graph that the range of Δω satisfying the phase matching condition represented by Expression (1) exits in relatively a small area at locations away from the frequency of the excitation light. Therefore, as shown in FIG. 8B, when excitation light of a particular frequency is incident upon the nonlinear optical medium, the optical parametric gain G exists in relative small frequency bands, and a signal light and an idler light are generated in narrow frequency bands.

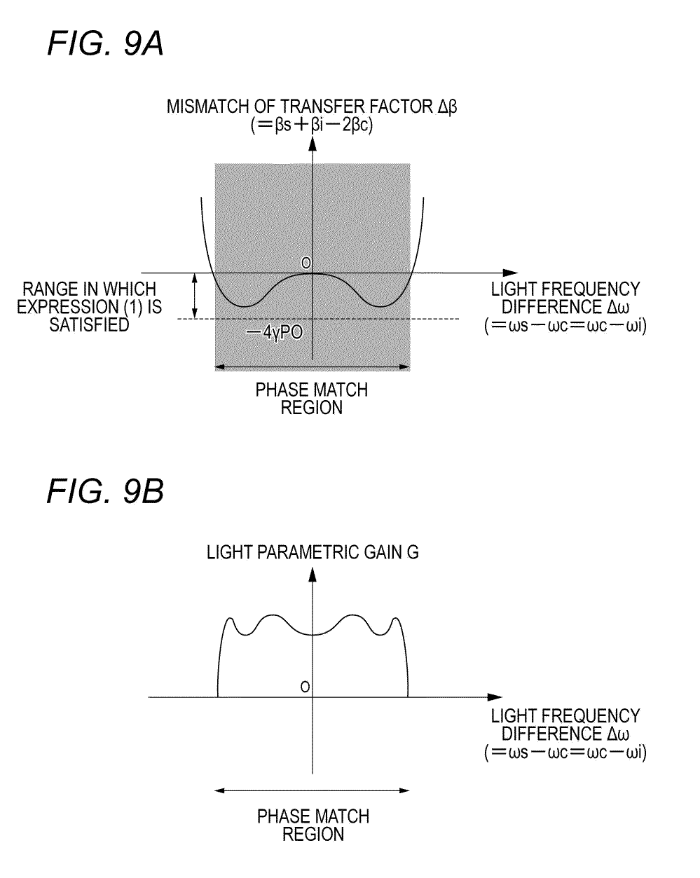

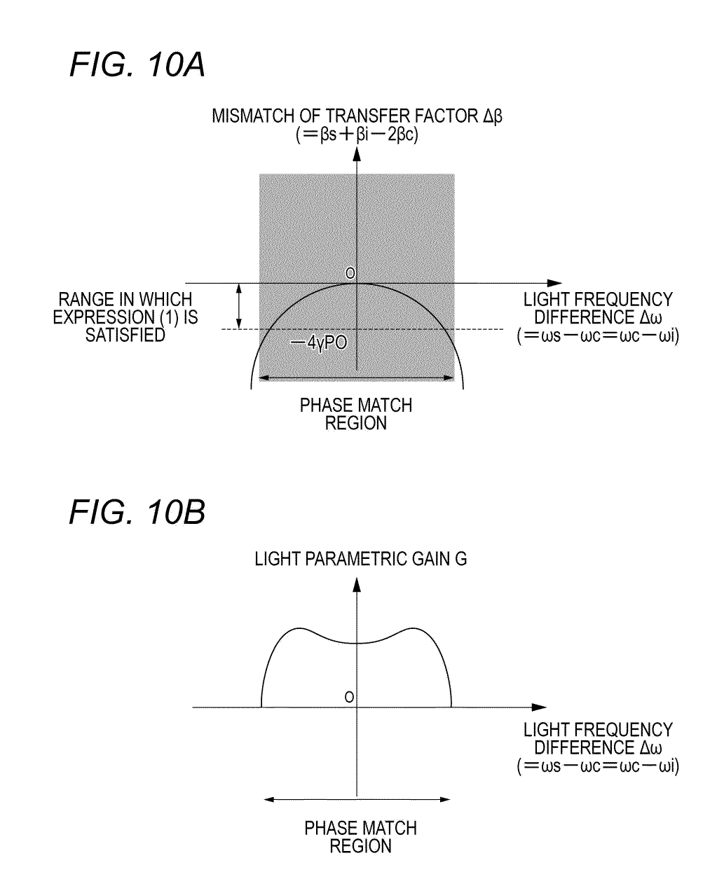

FIGS. 9A and 9B illustrate a case where β₂<0 and β₄>0 hold. FIGS. 10A and 10B illustrate a case where β₂<0 and β₄<0 hold. As shown in FIGS. 9A and 10A, it is understood that when the excitation light is operated in an area of β₂<0 (abnormal dispersion area), the range of Δω satisfying the phase matching condition represented by Expression (1) is relatively large. More specifically, as shown in FIGS. 9B and 10B, when a pulse light of a particular frequency is incident upon the nonlinear optical medium, the optical parametric gain G exists in a relatively large frequency band, and signal light and an idler light are generated over a wide frequency band.

As can be understood from the above, in order to generate a pulse light having a narrow spectrum width using degenerate four-wave mixing, the nonlinear optical medium satisfying β₂>0 and β₄<0 is used. Such nonlinear optical medium is achieved by selecting a core material and a clad material and designing the shape of the optical fiber so that the refraction index between the core and the clad of the optical fiber becomes an appropriate value.

The frequency shift amount Δω (wavelength shift amount Δλ) of the signal light and idler light generated by the degenerate four-wave mixing with respect to the excitation pulse light, and the frequency width δω (spectrum half-width δλ) of the signal light and the idler light are each expressed by the following expressions.

$$\begin{matrix}Δ ω = \sqrt{\frac{12 {β}_{2}}{\vert {β}_{4} \vert}} = \sqrt{\frac{12 {β}_{3} ( {ω}_{c} - {ω}_{0} )}{\vert {β}_{4} \vert}} & Expression 4 \\ Δ λ = \frac{1}{A} \sqrt{\frac{12 {β}_{2}}{\vert {β}_{4} \vert}} = \frac{1}{A} \sqrt{\frac{12 {β}_{3} A ( {λ}_{0} - {λ}_{c} )}{\vert {β}_{4} \vert}} A = \frac{2 π c}{{λ}_{0}^{2}} & Expression 5 \\ δ ω = \frac{24 γ {P}_{c}}{\vert {β}_{4} \vert Δ {ω}^{3}} & Expression 6 \\ δ λ = \frac{24 γ {P}_{c}}{{A}^{4} \vert {β}_{4} \vert Δ {λ}^{3}} & Expression 7\end{matrix}$$

ω₀ denotes a zero dispersion frequency of a nonlinear optical medium. λ_{C} denotes the center wavelength of the excitation pulse light. λ₀ denotes a zero dispersion wavelength of the nonlinear optical medium. β₃ denotes a primary derived function of the group velocity dispersion β₂ at the zero dispersion wavelength. c denotes the speed of light. As can be shown in Expression (5), when the center wavelength of the excitation pulse light λ_{C} is slightly changed, the wavelength of the signal light (or idler light) can be greatly changed by an amount of coefficient of Expression (5). It is understood that, as can be shown in Expression (7), when a nonlinear optical medium of which nonlinear coefficient γ is small and of which β₄ is large is used, a signal light (or idler light) having a narrow spectrum width δλ can be generated. Any one of or both of the lights of the signal light and the idler light can be used as the generated pulse light.

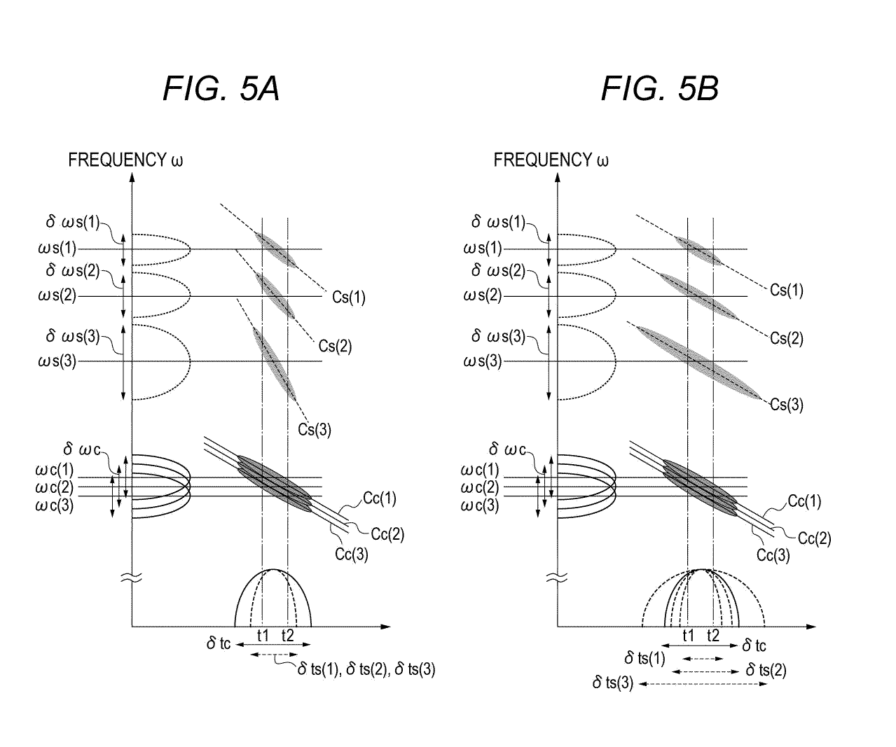

A method of adjusting the chirp rate of the generated pulse light on the basis of the principle of generation of the four-wave mixing explained above will be explained. FIGS. 5(a) and 5 (b) are spectrograms illustrating distributions of a time component and a frequency component included in the excitation pulse light and the generated pulse light where the horizontal axis is the time and the vertical axis is the frequency on the basis of Expressions (6) and (7). The spectrograms of the excitation pulse lights are represented by ellipses in a dark color, and the spectrograms of the generated pulse lights (the signal lights in FIGS. 5A and 5B) are represented by ellipses in a light color. In the drawings, for the sake of simplification, three excitation pulse lights having center wavelengths different from each other and generated pulse lights generated thereby are shown.

In FIGS. 5A and 5B, the chirp rates C_{C}(n)=δω_{C}(n)/δt_{C}(n) of excitation pulse lights of which frequencies are ω_{C} (1), ω_{C} (2), ω_{C} (3) are represented by inclinations C_{C} (1), C_{C} (2), C_{C} (3) of the ellipses. In this case, n is a symbol simply indicating that the center wavelength of the excitation pulse light (frequency) is different.

The spectrum width δω_{C}(n) and the pulse duration δt_{C}(n) of the excitation pulse lights are constant regardless of the center wavelength (regardless of n), and therefore, the chirp rate C_{C}(n) is also constant. The spectrum widths of the generated pulse lights of which frequencies are ω_{S} (1), ω_{S} (2), ω_{S} (3) which are generated by the excitation pulse lights of which frequencies are ω_{C} (1), ω_{C} (2), ω_{C} (3), respectively, are represented by δω_{S} (1), δω_{S} (2), δω_{S} (3). The chirp rates C_{S}(n) (C_{S}(n)=δω_{S} (n)/δt_{S}(n)) are represented by inclinations C_{S} (1), C_{S} (2), C_{S} (3) of the ellipses.

FIG. 5A indicates a case where the chirp rate of the generated pulse light is not adjusted. FIG. 5B indicates a case where the chirp rate is adjusted.

As can be understood from Expression (5) and FIGS. 5A and 5B, the shift amount Δω of the center wavelength of the generated pulse light changes in accordance with the change of the center wavelength of the excitation pulse light, and the spectrum width δω_{S} of the generated pulse light represented by Expression (6) also changes. However, the pulse duration δt_{S} of the generated pulse light is substantially constant regardless of the center wavelength of the excitation pulse light.

As shown in FIG. 5A, when the chirp rate of the generated pulse light is not adjusted, the chirp rate C_{S} of the generated pulse light changes in accordance with the change in the center wavelength of the excitation pulse light, and the chirp rate of the excitation pulse light and the chirp rate C_{C} of the generated pulse light do not match each other. More specifically, the frequency difference of the excitation pulse light and the generated pulse light is not maintained constantly within the pulse duration.

In such state, for example, a case will be considered in which the excitation pulse light of the frequency ω_{C} (3) and the generated pulse light of the frequency ω_{S} (3) generated therefrom are emitted on a subject. In FIG. 5A, the frequency difference of the excitation pulse light and the generated pulse light at t1 corresponds to a difference between line C_{C}(3) and line C_{S}(3) at t1, and the frequency difference of the excitation pulse light and the generated pulse light at t2 corresponds to a difference between a line representing C_{C}(3) and a line representing C_{S}(3) at t2. In a measurement of a molecule having a certain molecular vibration number, when the frequency difference between the excitation pulse light and the generated pulse light at t1 exactly matches the molecular vibration number, the frequency difference between the excitation pulse light and the generated pulse light at t2 deviates from the molecular vibration number.

As described above, when the frequency difference of the two pulse lights emitted onto the subject within the pulse duration, this reduces the time in which the frequency difference corresponding to the molecular vibration number of the molecule of the subject is maintained. As a result, the energy of the excitation pulse light and the generated pulse light cannot be efficiently used for generation of Stimulated Raman Scattering light corresponding to the molecular vibration number of the molecule constituting the subject. Therefore, the signal strength obtained from the subject as result is reduced, and accordingly, the spectral of the Raman spectrum deteriorates.

As shown in FIG. 5B, the light source apparatus can give a wavelength dispersion to the generated pulse light so that the chirp rates of the generated pulse light and the excitation pulse light immediately before emission to the subject become equal to each other. More specifically, in accordance with the change of the center wavelength of the excitation pulse light, the given wavelength dispersion amount is changed by the wavelength dispersion adjustment device, and the pulse duration of the generated pulse light is successively changed, and the chirp rate of the generated pulse light immediately before the emission of the subject is caused to match the chirp rate of the excitation pulse light. As a result, the frequency difference of the excitation pulse light and the generated pulse light on the subject can be maintained at a substantially constant level within the pulse duration regardless of the center wavelength of the excitation pulse light, and the energy of the pulse light emitted to the subject can be efficiently used for generation of Stimulated Raman Scattering light.

It should be noted that “the chirp rates of the generated pulse light and the excitation pulse light are equal to each other” referred to herein means that the difference of the chirp rates of the generated pulse light and the excitation pulse light is equal to or less than a predetermined value. In addition, “the chirp rate of the generated pulse light is caused to match the chirp rate of the excitation pulse light” is also used in a similar meaning.

It should be noted that the predetermined value may be a value with which the information-obtaining apparatus having the light source apparatus incorporated therein can obtain a required spectral resolution of Raman spectrum from the subject, and more specifically, the predetermined value may be several cm⁻¹ or less. This condition may be expressed by the following expressions.

$$0 \leq \vert \frac{{δω}_{c}}{δ {t}_{c}} - \frac{γ {P}_{c}}{δ {t}_{s}} \sqrt{\frac{\vert {β}_{4} \vert}{{3 [ {β}_{3} ( {ω}_{c} - {ω}_{0} ) ]}^{3}}} \vert \leq \frac{1000 π c}{δ {t}_{c}} \qquad Expression 8$$

δω_{C} is the frequency width of the excitation pulse light, and δt_{C} is the pulse duration of the excitation pulse light.

Hereinafter, embodiments of the light source apparatus and the information-obtaining apparatus according to the present inventions will be explained with reference to drawings, but the present inventions are not at all limited to the constituent elements and the like of the embodiments. In each of the drawings, members denoted with the same reference numerals mean the same members or corresponding members.

### First Embodiment

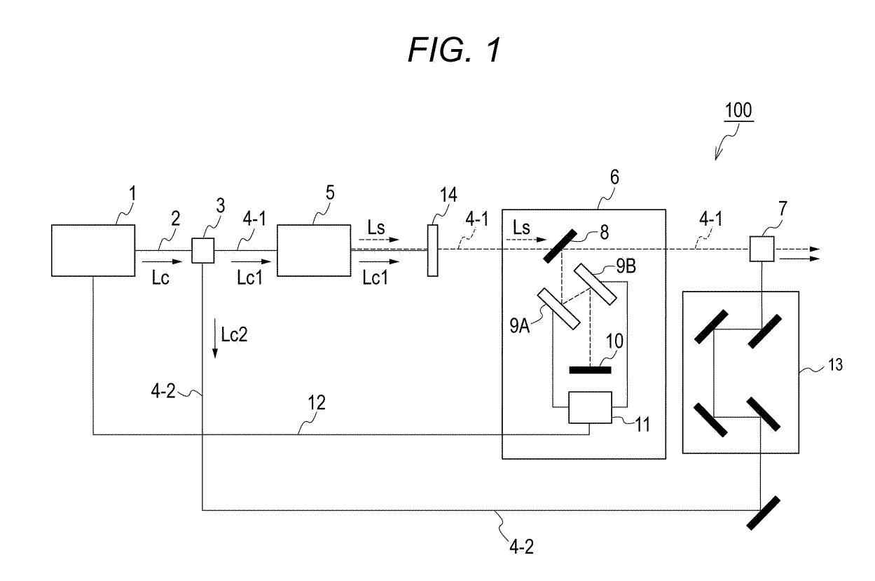

FIG. 1 illustrates a schematic view of a light source apparatus 100. A light source 1 can emit a first pulse light (excitation pulse light) of which center wavelength λ_{C} is variable. The light source 1 is preferably, for example, pulse laser having a wavelength filter in a laser resonator and capable of changing the wavelength within the gain band of the laser medium.

A first pulse light L_{C} emitted from the light source 1 passes through an optical path 2, and branches, at a dividing device 3, into a light L_{C1} advancing to an optical path 4-1 and a light L_{C2} advancing to an optical path 4-2. The first pulse light L_{C1} branched to the optical path 4-1 is guided to a nonlinear optical medium 5. When the first pulse light is incident thereupon, the nonlinear optical medium 5 generates a second pulse light (generated pulse light) L_{S} having a center wavelength λ_{S} different from the first pulse light according to the optical parametric gain of the nonlinear optical medium 5. The second pulse light L_{S} generated by the nonlinear optical medium 5 is multiplexed with the first pulse light L_{C2} by a multiplexing device 7 to be emitted. The spectrum width of the pulse light emitted from the light source 1 is preferably equal to or less than 1 nm. This is because the narrower the spectrum width of the pulse light is, the more efficient the four-wave mixing occurs in the nonlinear optical medium 5, and accordingly the optical parametric gain is sufficiently ensured.

When emitted from the light source apparatus 100, the chirp rates of the first pulse light and the second pulse light immediately before emission to the subject are caused to match each other, and therefore, a wavelength dispersion adjustment device 6 is provided between the nonlinear optical medium 5 and the multiplexing device 7. In the present embodiment, a band pass filter 14 cutting off pulse lights other than the second pulse X_{S} is inserted, but depending on the constituting, the band pass filter 14 may be omitted.

The wavelength dispersion adjustment device 6 includes a mirror 10 and a pair of diffraction gratings 9 (9A, 9B) of which mutual interval can be adjusted by, e.g., an actuator, not shown. The second pulse light L_{S} generated by the nonlinear optical medium 5 advances to a wavelength dispersion adjustment device 6 by way of an optical path 4-1, and the advancing direction is changed by a mirror 8. Then, the second pulse light L_{S} passes the pair of diffraction gratings 9, and reflected by a mirror 10. Then, the second pulse light L_{S} passes the pair of diffraction gratings 9 again and return back to the original optical path 4-1. When the second pulse light passes the pair of diffraction gratings 9, a wavelength dispersion of an amount according to the interval between the diffraction gratings 9A and 9B constituting the pair of diffraction gratings 9 is given to the second pulse light.

For example, when the center wavelength of the first pulse light is configured to be longer (the frequency is reduced), and the given wavelength dispersion amount is increased by increasing the interval between the diffraction gratings 9A and 9B, the chirp rate can be reduced by increasing the pulse duration. As described above, when the pulse duration of the second pulse light is changed by adjusting the given wavelength dispersion amount, the second pulse light chirp rate can be adjusted.

The interval of the diffraction gratings 9A and 9B constituting the pair of diffraction gratings 9, i.e., the wavelength dispersion amount given to the second pulse light, can be controlled by a control unit 11 in accordance with the center wavelength of the first pulse light 2 emitted from the light source 1. The control unit 11 calculates the wavelength dispersion amount given to the second pulse light from the center wavelength of the first pulse light, and controls the interval between the diffraction gratings 9A and 9B.

More specifically, the interval of the diffraction gratings 9A and 9B when the center wavelength of the excitation pulse light is the shortest is adopted as the reference, and the longer the center wavelength of the excitation pulse light is, the wider the interval of the diffraction gratings 9A and 9B may be. Upon receiving data of the center wavelength of the first pulse light sent from the light source 1, the control unit 11 determines the interval of the diffraction gratings 9A and 9B from the held table and conversion expression. Then, on the basis of the calculated value, at least one of the diffraction gratings 9A and 9B is moved by driving means such as an actuator. The table and conversion expression for determining the interval of the diffraction gratings 9A and 9B are determined in view of dispersion characteristics of the structure of the information-obtaining apparatus having the light source apparatus incorporated therein. The table and conversion expression suitable for the structure of the information-obtaining apparatus combined with the light source apparatus 100 may be saved to a memory provided with the control unit 11.

A pair of prisms may be used instead of the pair of diffraction gratings 9. When the pair of prisms is used, the chirp rate of the second pulse light can be likewise adjusted by adjusting the distance between the prisms constituting the pair of prisms.

FIG. 1 shows the structure in which the wavelength dispersion adjustment device 6 is provided only in the optical path 4-1. Alternatively, the wavelength dispersion adjustment device 6 may be provided in both of the optical paths 4-1 and 4-2, and the wavelength dispersion may be given to both of the pulse lights so that the difference of the chirp rates of the first pulse light and the second pulse light immediately before the emission of the subject matches.

In the present embodiment, a delay 13 is inserted into the optical path 4-2, so that the emission timing of the first pulse light and the second pulse light are adjusted, but the delay 13 may not be necessarily provided in the light source apparatus. For example, when a delay is provided at the side of the information-obtaining apparatus having the light source apparatus 100 incorporated therein, the delay 13 may be omitted.

### Second Embodiment

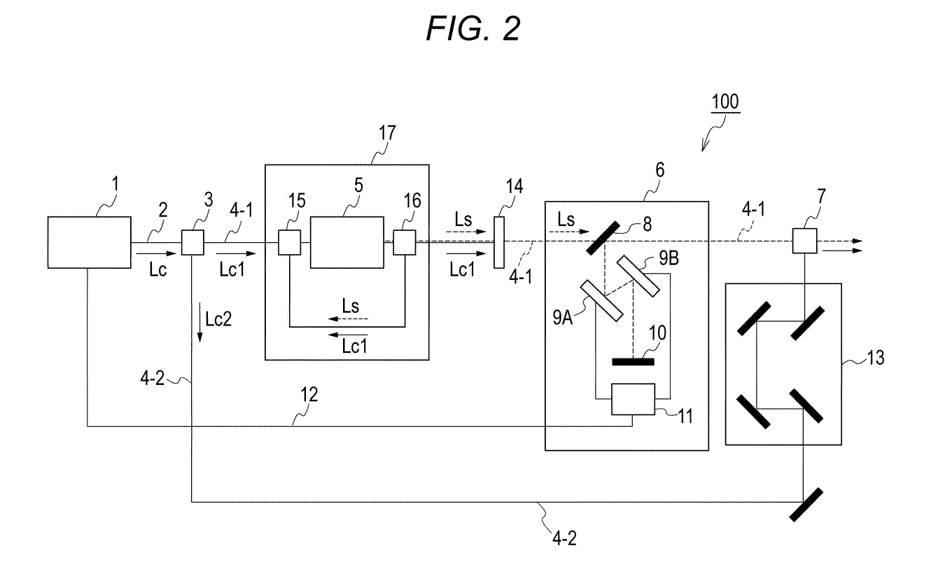

FIG. 2 illustrates another embodiment of a light source apparatus. The present embodiment is different from the light source apparatus according to the first embodiment in that the present embodiment has a fiber optical parametric oscillator (which may be hereinafter abbreviated as FOPO). For example, those shown in the first embodiment can be employed as the elements such as the dividing device 3, the nonlinear optical medium 5, wavelength dispersion adjustment devices 6-1, 6-2, and the like.

The first pulse light of the center wavelength 2 emitted from the light source 1 passes the optical path 2, and branches at the dividing device 3, to the light L_{C1} advancing to the optical path 4-1 and the light L_{C2} advancing to the optical path 4-2. The first pulse light L_{C1} branching to the optical path 4-1 is guided to a resonator (fiber optical parametric oscillator) 17 including the nonlinear optical medium 5 via the multiplexing device 15, and the second pulse light L_{S} is generated.

In the present embodiment, the nonlinear optical medium 5 is provided in the resonator, and therefore, the first pulse light L_{C1} and the second pulse light L_{S} can be repeatedly passed through the nonlinear optical medium 5. Every time the first pulse light L_{C1} passes through the nonlinear optical medium 5 in the resonator, the second pulse light L_{S} of the center wavelength λ_{S} is generated. As described above, the first pulse light L_{C1} and second pulse light L_{S} are circulated in the resonator to perform parametric oscillation, so that the strength of the second pulse light L_{S} can be enhanced. The second pulse light L_{S} oscillated by the resonator 17 is retrieved out of the resonator 17 via the dividing device 16.

When the resonator 17 is provided, the pulse rate of the first pulse light L_{C} is preferably an integral multiple of a free spectral range (hereinafter abbreviated as FSR) of the resonator at the wavelength)_{S} of the second pulse light L_{S}. When such relationship is satisfied, the second pulse light is efficiently oscillated in the resonator, and can be retrieved as a pulse light having a high peak strength.

Like the first embodiment, the wavelength dispersion adjustment device 6 gives a wavelength dispersion to the second pulse light L_{S} retrieved from the resonator 17 and having passed the band pass filter 14, so that the chirp rate is adjusted. Then, the chirp rates of the first pulse light and the second pulse light immediately before emission to the subject are caused to match each other. The second pulse light L_{S} of which chirp rate has been adjusted is multiplexed by the multiplexing device 7 with the first pulse light L_{C1} having passed the optical path 4-2 and emitted.

The light source apparatus according to the present embodiment having the nonlinear optical medium 5 disposed in the resonator is able to keep balance of the peak strengths of the first pulse light and the second pulse light more easily than the first embodiment. In addition, the peak strength of the second pulse light can be at a high level, and therefore, the present embodiment is preferable for the information-obtaining apparatus that requires a pulse light of a high peak strength.

### Third Embodiment

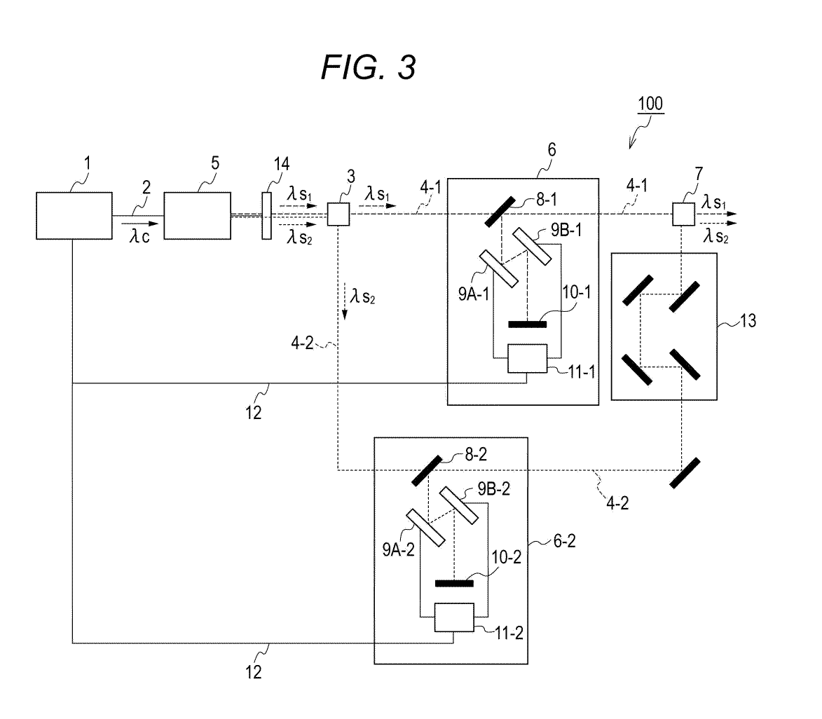

FIG. 3 illustrates another embodiment of a light source apparatus. The present embodiment is different from other embodiments in that a signal light and an idler light generated by a nonlinear optical medium are emitted in response to incidence of excitation pulse light.

A first pulse light (excitation pulse light) L_{C} of a center wavelength λ_{C} emitted from a light source 1 is caused to incident upon a nonlinear optical medium 5, so that two generated pulse lights, i.e., a second pulse light (signal light) L_{S1} of a center wavelength λ_{S1} and a third pulse light (idler light) L_{S2} of a center wavelength λ_{S2}, are generated. Of the three pulse lights retrieved from the nonlinear optical medium 5, the first pulse light is cut off by the band pass filter 14, and thereafter, the dividing device 3 causes the light to be branched into a second pulse light L_{S1} and a third pulse light L_{S2}. The second pulse light L_{S1} advances to an optical path 4-1, and a wavelength dispersion adjustment device 6-1 gives a wavelength dispersion thereto, so that the pulse duration is adjusted. The third pulse light L_{S2} advances to an optical path 4-2, and the wavelength dispersion adjustment device 6-2 gives a wavelength dispersion thereto, so that the pulse duration is adjusted. Further, the third pulse light L_{S2} is intensity-modulated by a light modulation device 21. Then, the second pulse light L_{S1} and the third pulse light L_{S2} are multiplexed by the multiplexing device 7, and emitted from the light source apparatus 100. For example, those shown in the first embodiment can be employed as the elements such as the dividing device 3, the nonlinear optical medium 5, the wavelength dispersion adjustment devices 6-1, 6-2, and the like.

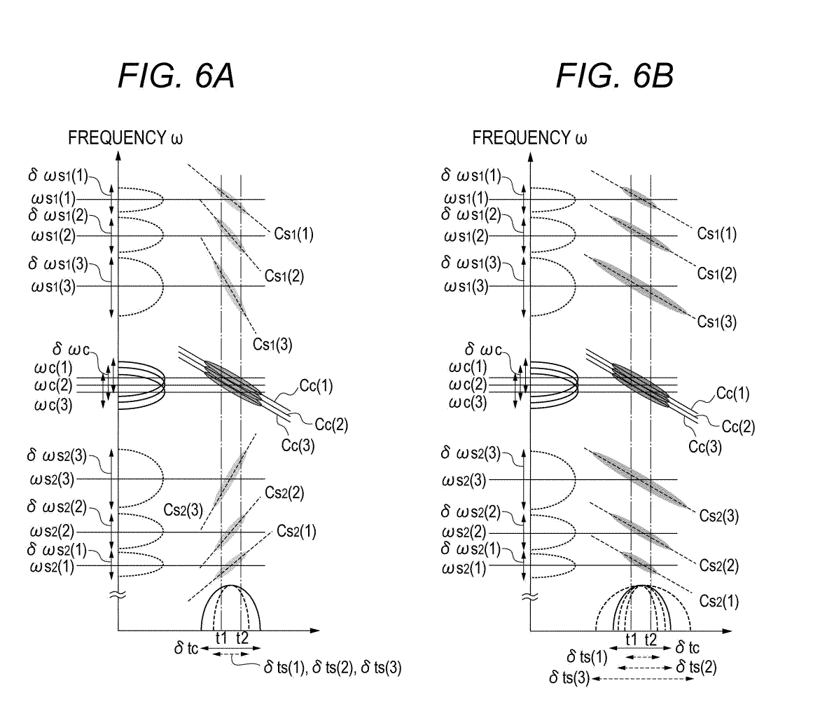

FIG. 6A illustrates a spectrogram illustrating a distribution of a time component and a frequency component included in excitation pulse light and generated pulse light in a case where the chirp rate of the generated pulse light is not adjusted. The chirp rates C_{C}(n) of the excitation pulse light of which frequency is ω_{C} (1), ω_{C} (2), ω_{C} (3) are inclinations C_{C} (1), C_{C} (2), C_{C} (3) of ellipses, respectively. The frequencies of the signal light L_{S1} generated by the excitation pulse light L_{C} of which frequency is ω_{C} (1), ω_{C} (2), ω_{C} (3) are ω_{S1} (1), ω_{S1} (2), ω_{S1} (3), respectively, and the spectrum widths thereof are δω_{S1} (1), δω_{S1} (2), δω_{S1} (3). The chirp rates thereof are C_{S1} (1), C_{S1} (2), C_{S1} (3), respectively. The frequencies of the idler light L_{S2} generated by the excitation pulse light L_{C} of which frequency is ω_{C} (1), ω_{C} (2), ω_{C} (3) are ω_{S2} (1), ω_{S2} (2), ω_{S2} (3), respectively, and the spectrum widths thereof are δω_{S2} (1), δω_{S2} (1), δω_{S2} (2), δω_{S2} (3), respectively. The chirp rates thereof are C_{S2} (1), C_{S2} (2), C_{S2} (3), respectively.

As can be understood by comparing FIG. 6A with FIG. 5A, the present embodiment using the signal light and the idler light as the two pulses emitted from the light source apparatus 100 can more greatly increase the variable width of the frequency difference of the two pulses than the other embodiments. However, since the difference of the chirp rate of the signal light L_{S1} and the idler light L_{S2} within the pulse duration is large, it is not possible to be simply applied to an information-obtaining apparatus using SRS and CARS.

In contrast, FIG. 6 B is a spectrogram illustrating a distribution of a time component and a frequency component included in the excitation pulse light L_{C} and the generated pulse lights L_{S1}, L_{S2} in a case where the chirp rate of the generated pulse light is adjusted in the light source apparatus according to the present embodiment.

In FIG. 6A, the wavelength dispersion amount according to the center wavelength of the first pulse light L_{C} is given to the two generated pulse lights, and more specifically, the second pulse light L_{S1} and the third pulse light L_{S2}, so that a frequency difference within an extremely large pulse duration can be reduced. At this occasion, with regard to the center wavelength of the same excitation pulse light L_{C}, the wavelength dispersion amount given to the second pulse light L_{S1} and the wavelength dispersion amount given to the third pulse light L_{S2} are different from each other.

For the second pulse light L_{S1}, like the other embodiments, the interval of the diffraction gratings 9A and 9B when the center wavelength of the excitation pulse light L_{C} is the shortest is adopted as the reference, and the longer the center wavelength of the excitation pulse light L_{C} is, the wider the interval thereof may be. For the third pulse light L_{S2}, likewise, the interval of the diffraction gratings 9A and 9B when the center wavelength of the excitation pulse light is the shortest is adopted as the reference, and the longer the center wavelength of the excitation pulse light is, the wider the interval thereof may be. However, as can be understood from FIGS. 6A and 6B, this is a value larger than the wavelength dispersion amount given to the third pulse light L_{S2} and the wavelength dispersion amount given to the second pulse light L_{S1}.

The light source apparatus according to the present embodiment can increase the wavelength difference of two wavelengths, and is suitable for the information-obtaining apparatus desired to observe a high Raman frequency. In addition, the generated pulse light has less noise component, and therefore, only the generated pulse light is used for obtaining information, so that a preferable SN ratio can be achieved.

### Fourth Embodiment

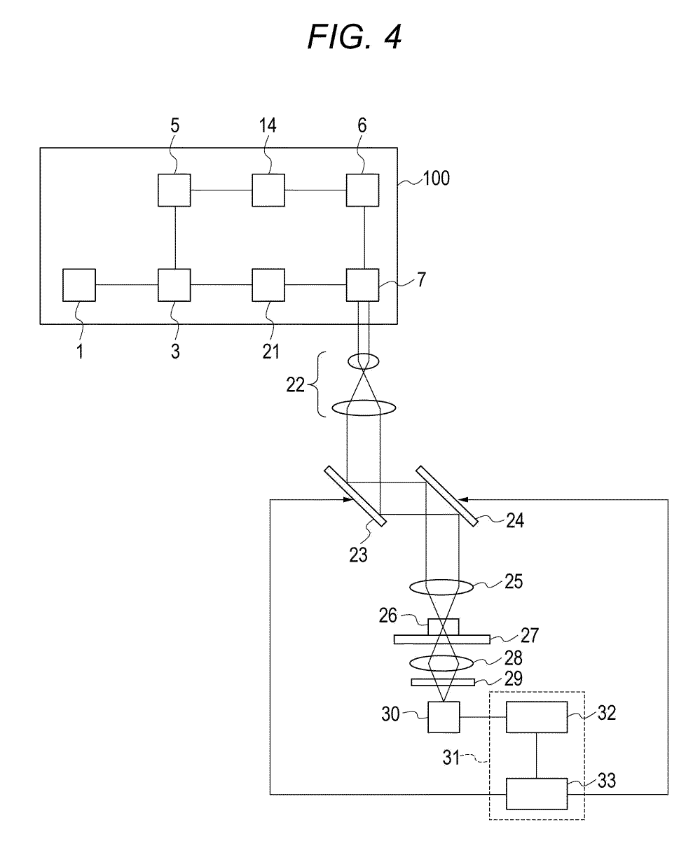

FIG. 4 is a schematic diagram illustrating an information-obtaining apparatus according to the present embodiment. In the present embodiment, a microscope performing SRS imaging using the light source apparatus 100 explained in the first embodiment (SRS microscope) is used as an example of apparatus for explanation.

The SRS imaging is a method for obtaining molecule vibrational imaging by using a phenomenon called Stimulated Raman Scattering in which Stokes light is amplified by interference between a pump light and the Stokes light incident upon a material. More specifically, while one of the two pulse lights of which wavelengths are different from each other, i.e., the Stokes light, is intensity-modulated, the two pulse lights are synchronized and emitted onto the subject. When the difference frequency of the two wavelengths matches the molecular vibration number of the molecule constituting the subject, Stimulated Raman Scattering occurs, and the intensity-modulated Stokes light is amplified. At this occasion, in accordance with the intensity modulation of the Stokes light, the pulse light that is not intensity-modulated, i.e., the pump light, is also intensity-modulated, and by detecting the intensity-modulated portion based on Stimulated Raman Scattering of the pump light emitted from the subject, the molecule vibrational imaging of the subject can be done. In addition, by changing the difference frequency of the two pulse lights by changing the center wavelength of the pulse light, it is possible to match the molecular vibration numbers of various molecules, and a signal peculiar to a molecule group constituting the subject can be obtained.

The excitation pulse light (first pulse light) 2 emitted by the light source 1 is branched by the dividing device 3 into two, and one of the lights is modulated by the light modulation device 21 to be used as the Stokes light for an SRS microscope. The other of the lights is caused to be incident upon the nonlinear optical medium 5, so that a signal light and an idler light are generated. Any one of the signal light and the idler light (the signal light in the present embodiment) is retrieved as a generated pulse light (second pulse light) λ_{S} via the band pass filter 14. The nonlinear optical medium 5 may be preferably made of an optical fiber satisfying the conditions of β₂>0 and β₄<0 and having a high nonlinear coefficient. The generated pulse light retrieved from the band pass filter 14 is caused to be incident upon the wavelength dispersion adjustment device 6, and the wavelength dispersion amount according to the center wavelength of the excitation pulse light is given thereto. The generated pulse light of which chirp rate has been adjusted by the wavelength dispersion adjustment device 6 is used as the pump light for an SRS microscope.

The Stokes light and the pump light are multiplexed by the multiplexing device 7 and emitted onto the subject. The multiplexing device 7 configured to multiplex multiple pulse lights having center wavelengths different from each other may be a light coupler, a diffraction grating, a prism, and the like.

The Stokes light and the pump light multiplexed pass a beam expander 22, an X scan mirror 23, a Y scan mirror 24, and an object lens 25, and are condensed on a subject 26 provided on a stage 27.

On the subject 26, Stimulated Raman Scattering based on the molecule vibration of the molecule occurs in a very small area at the center of the light-condensed point of the object lens 25, and therefore, the intensities of the pump light and the Stokes light change. The Stimulated Raman Scattering does not occur in places out of the very small area at the center of the light-condensed point, and therefore, the strengths of the pump light and the Stokes light do not change. The size of the spot of the light emitted onto the subject 26 decreases as the NA of the object lens 25 increases, and accordingly, the size of the very small area where the Stimulated Raman Scattering occurs is also reduced.

At this occasion, the wavelength dispersion adjustment device 6 adjusts the chirp rate of the second pulse light, so that at the light-condensed point, the frequency difference of the Stokes light and the pump light is substantially constant within the pulse duration, so that the Stimulated Raman Scattering can be generated efficiently. When the wavelength dispersion adjustment device 6 adjusts the chirp rate, the wavelength dispersion given from when each pulse light is emitted from the wavelength dispersion adjustment device 6 to when it is emitted to the subject is also taken into consideration, and the chirp rates of the first pulse light and the second pulse light are caused to match each other immediately before emission to the subject. More specifically, the chirp rate is adjusted in view of the wavelength dispersion characteristics of the optical members provided on the optical path such as the multiplexing device 7, the beam expander 22, the X scan mirror 23, the Y scan mirror 24, the object lens 25.

The pump light intensity-modulated by the Stimulated Raman Scattering generated in the very small area at the center of the light-condensed point passes a light condensing lens 28 and a band pass filter 29, and thereafter incident upon the light reception device 30 to be detected as an SRS signal, and is obtained as an image signal by an information-obtaining unit 31.

In general, the Raman scattering cross-section σ of the molecule is small, and therefore, the change in the strength of the pump light due to the Stimulated Raman Scattering is very weak. For this reason, when an SRS signal is detected from the change in the strength of the pump light, the SRS signal may be buried in the noise component and the like. In the present embodiment, the information-obtaining unit 31 including a synchronous detection device 32 and control means 33 is used, and the intensity modulation of the pump light received by the light reception device 30 and converted into an electric signal is detected in synchronization with the modulation frequency of the light modulation device, so that the molecule vibrational imaging of the subject 26 is obtained. When the synchronous detected signal is amplified, the SRS signal can be detected with a high sensitivity.

The synchronous detection device 32 may be made of a lock-in amplifier, an FFT analyzer, and the like, but an FFT analyzer can detect an SRS signal at a higher speed than a lock-in amplifier. FIG. 4 illustrates the synchronous detection device 32 and the control means 33 provided as separate bodies. Alternatively, an information-obtaining unit 31 which integrally includes the synchronous detection device 32 and the control means 33 may be used. An example where the synchronous detection device 32 and the control means 33 are provided integrally includes, e.g., a computer having a CPU used as the control means 33 includes an application having a synchronous detection function.

When the X scan mirror 23 is driven, a light-condensed point can scan in an X direction in the subject 26, and when the Y scan mirror 24 is driven, a light-condensed point can scan in a Y direction perpendicular to the X direction in the subject 26. Therefore, when the light-condensed point scans on the subject 26 using the X scan mirror 23 and the Y scan mirror 24, a two-dimensional image can be obtained.

Further, after a single two-dimensional scan is finished, the light-condensed point is moved in the optical axis direction by a predetermined distance by moving the stage 27, and the same two-dimensional scan is repeated, whereby a three-dimensional image of the subject 26 can be obtained.

When the center wavelength of the pulse laser 1 is changed after a single two-dimensional scan or three-dimensional scan is finished, the difference frequency of two wavelengths of the pump light and the Stokes light is changed, so that it is possible to match the molecular vibration number of various molecules included in the subject 26. Therefore, a two-dimensional or three-dimensional molecule vibrational image can be obtained.

The pulse duration of the pulse light emitted from the light source 1 used for an SRS microscope according to the present embodiment is preferably equal to or less than 1 ns, and more preferably, equal to or less than 100 ps. This is because the narrower the pulse duration of the pulse light is, the larger the peak strength of the pulse light is, and accordingly, presence/absence of the nonlinear effect generated on the subject 26 can be detected with a higher degree of accuracy. The pulse rate of the pulse light emitted from the light source 1 is preferably equal to or more than 1 MHz and equal to or less than 1 GHz. This is because the pulse rate of the pulse light is preferably equal to or more than 1 MHz because of the limitation of the measurement speed practically required as the SRS microscope, and is preferably equal to or less than 1 GHz because of the limitation of thermal breakdown caused in the subject 26.

An SRS microscope is preferably used for observation of a living tissue, and therefore, each pulse light emitted from the light source 1 has preferably a wavelength that is less likely to be reflected, absorbed, and scattered by a living body and is more likely to pass through a living body. Therefore, the center wavelength of each pulse light emitted from the light source 1 is preferably equal to or more than 300 nm and equal to or less than 1500 nm, and more preferably, equal to or more than 700 nm and equal to or less than 1300 nm. For example, the light source 1 is preferably a mode synchronization Yb (ytterbium) doped fiber laser.

As described above, the SRS microscope according to the present embodiment can cause the chirp rates of the pump light and the Stoke lights of the Stimulated Raman Scattering to match each other successively in accordance with the change in the center wavelength of the pulse light. Therefore, the spectral resolution of the Raman spectrum obtained from the subject 26 can be improved, and a clear image of a high SN ratio can be obtained.

As compared with a conventional SRS microscope apparatus, the size of the light source apparatus can be reduced, and the cost of the light source apparatus can be reduced. Therefore, the size of the entire SRS microscope apparatus can be reduced, and the cost of the SRS microscope apparatus can be reduced.

In the present embodiment, two pulse lights are emitted onto the subject, and at least one of the light reflected by the subject, the light passing through the subject, and the light emitted in the subject is detected, and the SRS microscope is explained as an example of the information-obtaining apparatus for obtaining information about the subject. However, the present embodiment is not limited thereto. Like the present embodiment, the light source apparatus according to the first embodiment to the third embodiment can also be used for information-obtaining apparatuses such as a CARS microscope, a fluorescence microscope, and an endoscope.

When the light source apparatus is used, the difference of the chirp rates of the excitation pulse light and the generated pulse light immediately before emission to the subject can be configured to be equal to or less than a predetermined value. In addition, the information-obtaining apparatus can increase the spectral resolution of the Raman spectrum obtained from the subject regardless of the center wavelength of the excitation pulse light.

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

This application claims the benefit of Japanese Patent Application No. 2014-074581, filed Mar. 31, 2014, which is hereby incorporated by reference herein in its entirety.

What is claimed is:

1. A light source apparatus emitting two pulse lights of which a center wavelength difference is variable, the light source apparatus comprising:
a light source configured to emit a first pulse light of which a center wavelength is variable;
a nonlinear optical medium configured to generate a second pulse light having a center wavelength different from the first pulse light in response to incidence of the first pulse light; and
a wavelength dispersion adjustment device configured to give a wavelength dispersion to the second pulse light,
wherein a wavelength dispersion amount given by the wavelength dispersion adjustment device is variable.

2. The light source apparatus according to claim 1, wherein the two pulse lights of which the center wavelength difference is variable that are emitted from the light source apparatus are the first pulse light and the second pulse light.

3. The light source apparatus according to claim 1, further comprising a wavelength dispersion adjustment device configured to give a wavelength dispersion to a third pulse light generated by the nonlinear optical medium in response to incidence of the first pulse light and having a center wavelength different from the first pulse light and the second pulse light,
wherein a wavelength dispersion amount given by the wavelength dispersion adjustment device giving the wavelength dispersion to the third pulse light is variable.

4. The light source apparatus according to claim 3, wherein the two pulse lights of which the center wavelength difference is variable that are emitted from the light source apparatus are the second pulse light and the third pulse light.

5. The light source apparatus according to claim 1, further comprising a control unit configured to control a wavelength dispersion amount given by the wavelength dispersion adjustment device,
wherein the control unit controls the wavelength dispersion amount upon receiving information about a center wavelength of the first pulse light.

6. The light source apparatus according to claim 5, wherein the wavelength dispersion adjustment device has a pair of diffraction gratings, and
the control unit changes the given wavelength dispersion amount by changing a distance of diffraction gratings included in the pair of diffraction gratings.

7. The light source apparatus according to claim 5, wherein the wavelength dispersion adjustment device includes a pair of prisms, and
the control unit changes the given wavelength dispersion amount by changing a distance between prisms included in the pair of prisms.

8. The light source apparatus according to claim 1, wherein the wavelength dispersion adjustment device more greatly increases the given wavelength dispersion amount when the center wavelength of the first pulse light is longer than a predetermined reference center wavelength.

9. The light source apparatus according to claim 1, further comprising a resonator oscillating the second pulse light,
wherein the nonlinear optical medium is disposed in the resonator.

10. The light source apparatus according to claim 9, wherein a pulse rate of the first pulse light is an integral multiple of a free spectral range of the resonator at a center wavelength of the second pulse light.

11. The light source apparatus according to claim 1, further comprising a filter disposed between the nonlinear optical medium and the wavelength dispersion adjustment device, the filter operating to cut off the first pulse light having passed the nonlinear optical medium.

12. The light source apparatus according to claim 1, wherein the nonlinear optical medium includes a photonic crystal fiber.

13. The light source apparatus according to claim 1, wherein the nonlinear optical medium includes a taper fiber.

14. The light source apparatus according to claim 1, wherein a spectrum width of the first pulse light is equal to or less than 1 nm.

15. An information-obtaining apparatus configured to emit two pulse lights of which a center wavelength difference is variable to a subject, and obtain information about the subject by detecting at least one of a light reflected by the subject, a light passing through the subject, and a light emitted in the subject,
the information-obtaining apparatus comprising:
a light source apparatus configured to emit two pulse lights of which a center wavelength difference is variable; and
a light reception device configured to receive at least one of a light reflected by the subject, a light passing through the subject, and a light emitted in the subject,
wherein the light source apparatus comprises:
a light source configured to emit a first pulse light of which a center wavelength is variable;
a nonlinear optical medium configured to generate a second pulse light having a center wavelength different from the first pulse light in response to incidence of the first pulse light; and
a wavelength dispersion adjustment device configured to give a wavelength dispersion to the second pulse light,
wherein a wavelength dispersion amount given by the wavelength dispersion adjustment device is variable.

16. The information-obtaining apparatus according to claim 15, wherein a difference of a chirp rate of the first pulse light and a chirp rate of the second pulse light immediately before emission to the subject satisfies the following expression regardless of the center wavelength,
$$0 \leq \vert \frac{{δω}_{c}}{δ {t}_{c}} - \frac{γ {P}_{c}}{δ {t}_{s}} \sqrt{\frac{\vert {β}_{4} \vert}{{3 [ {β}_{3} ( {ω}_{c} - {ω}_{0} ) ]}^{3}}} \vert \leq \frac{1000 π c}{δ {t}_{c}} \qquad Expression 1$$
wherein δω_{C} denotes a frequency width of the first pulse light, δtᵤ denotes a pulse duration of the first pulse light, γ denotes a nonlinear coefficient of the nonlinear optical medium, P_{C} denotes a peak strength of the first pulse light, β₃ denotes a derived function of a group velocity dispersion β₂ of the nonlinear optical medium at a frequency of the first pulse light, β₄ denotes a secondary derived function of the group velocity dispersion β₂, ω_{C} denotes a frequency of the first pulse light, ω₀ denotes a zero dispersion frequency of the nonlinear optical medium, and c denotes the speed of light.

17. The information-obtaining apparatus according to claim 15, wherein both of pulse rates of the pulse lights of which center wavelengths are different from each other are equal to or more than 1 MHz and equal to or less than 1 GHz.

18. The information-obtaining apparatus according to claim 15, wherein spectrum widths of both of the pulse lights of which center wavelengths are different from each other are equal to or less than 1 nm.

19. The information-obtaining apparatus according to claim 15, further comprising:
an information-obtaining unit configured to obtain light, which is received by the light reception device, as an electric signal,
wherein the information-obtaining unit includes a synchronous detection device configured to obtain a signal in synchronization with a modulation of the light received by the light reception device.

20. A light source apparatus comprising:
a light source configured to emit a first pulse light of which a center wavelength is variable;
a nonlinear optical medium configured to generate a second pulse light having a center wavelength different from the first pulse light in response to incidence of at least a portion of the first pulse light and having a wavelength dispersion; and
a first adjustment unit configured to adjust a chirp rate of the second pulse light corresponding to a changing center wavelength of the first pulse light.
